(19) United States
(12) Patent Application Publication
(10) Pub. No.: US 2001/0036340 A1
(43) Pub. Date: Nov. 1, 2001

(54) Fiber-optics plug connector system as well as connecting clamp for such a plug connector system

(75) Inventor: Jakob Schoch, Schwellbrunn (CH)

Correspondence Address: TAROLLI, SUNDHEIM, COVELL, TUMMINO & SZABO L.L.P., 1111 Leader Building, Cleveland, OH, 44114, US

(73) Assignee: Huber & Suhner AG Degersheimerstrasse, Herisau (CH)

(21) Appl. No.: 09/776,315

(22) Filed: Feb. 2, 2001

(30) Foreign Application Priority Data
Apr. 27, 2000 (CH) CH 0826/00

(51) Int. Cl. G02B 6/38

(52) U.S. Cl. 385/71; 385/72; 385/78; 385/59

(57) ABSTRACT

In a fiber-optics plug connector system two fiber-optics single plug connectors (23, 24) are connected by a connecting clamp (10) in parallel arrangement to a multi-plug connector, wherein the connecting clamp (10) is comprised of two clamp halves (10a, 10b) which can be connected to one another by a snap connection and have receiving chambers (11, 12) for receiving and securing the two single plug connectors (23, 24) and wherein the single plug connectors (23, 24) each comprise a housing (27, 28) and an anti-kink sleeve (25, 26) adjoining the housing (27, 28) in the rearward direction.

In such a system, a simplified and flexible application for different plug types is achieved in that the single plug connectors (23, 24) are connected by the connecting clamp (10) in the area of their anti-kink sleeves (25, 26) and are secured in a parallel arrangement.

### TECHNICAL FIELD

The present invention relates to the field of connecting technology for fiber-optics systems. It relates to a fiber-optics plug connector system according to the preamble of the claim as well as a connecting clamp for such a plug connector system according to the preamble of claim 7.

Such a plug connector system and such a connecting clamp are known, for example, from published documents U.S. Pat. Nos. 5,123,071 or 5,343,547.

### PRIOR ART

For the detachable connection of single fiber-optics cables, single plug connectors (for example, simplex plug connectors or single plug connectors wherein several fibers are arranged parallel to one another in one plug and are connected simultaneously) of different embodiments are known in which the optical fiber(s) of the cable, for example, end(s) in a ferrule arranged in a plug housing. For connecting two plug connectors, they are then inserted from opposite sides into a coupling part so that the two ferrules abut one another with their end faces. Examples of simplex plug connectors or single plug connectors known to a person skilled in the art are ST or SC or MT-RJ or E2000 plug connectors.

If it is desired, for example, to connect in the case of simplex plug connectors two cables parallel in a duplex arrangement for the bidirectional information transmission, it was found to be expedient to combine and connect two simplex plug connectors in a parallel arrangement to a duplex plug connector by special devices which, for example, have the shape of clamps. Different solutions have been proposed for the technical realization of such duplex systems comprised of simplex plug connectors.

One of these solutions resides in that two adjacently positioned simplex plug connectors are to be connected by a special intermediate part. The intermediate part is arranged in the intermediate space between the two simplex plug connectors and can be connected with the housings of these plug connectors by snapping into place. Examples of such intermediate parts can be found, for example, in U.S. Pat. Nos. 4,953,929 or in 5,553,180 or in 5,579,425.

Another known solution resides in that the two simplex plug connectors with their plug housings are to be inserted and secured in a common frame. The attachment in the common frame can be realized by separate locking elements (U.S. Pat. No. 5,748,821) or by integrated catch devices on the frame and the plug connector housing (U.S. Pat. No. 5,613,025).

A further known solution employs special clamps which are snapped into place across the adjacently positioned plug connector housings. Here, the clamp can be formed as one-sided clamps (U.S. Pat. No. 5,675,682). However, it can also be comprised of two identical clamp halves which are placed from opposite sides about the plug connector housing and are then snapped into place on one another, respectively (U.S. Pat. Nos. 5,123,071 or 5,343,547).

Another known solution (U.S. Pat. No. 5,528,712) no longer uses a connection of the two simplex plug connectors in the area of the plug connector housing but employs instead a single-piece connector part which is comprised of two fixedly connected anti-kink sleeves and is combined with two simplex plug connector housings. A problem of this solution is that it is not possible to later combine in a simple way to finish-manufactured simplex plug connectors (with single anti-kink sleeve) but that the duplex plug connector must be manufactured as such from the start.

In the above described duplex plug connector systems the housings of the simplex plug connectors and the connecting means for producing the duplex plug connector from the two simplex plug connectors must be precisely matched to one another so that the housing and the connecting means will produce a safe and stable connection with one another. This has the result that for certain types and products of simplex plug connectors also only predetermined connecting means can be used, which, with respect to manufacture and storage of such connecting means, results in an increased expenditure and a lack of flexibility.

Moreover, for such a precise matching of the connector housings and connecting means it is mostly also necessary to make additional arrangements in order to provide sufficient play in the duplex plug connector for the insertion process of the two simplex plug connectors. For example, in the case of the aforementioned intermediate part of U.S. Pat. No. 4,953,929 a special elastic coupling member (43 in FIG. 7A thereof) is provided in order to allow a relative movement of the two simplex plug connectors to one another.

### DESCRIPTION OF THE INVENTION

It is therefore an object of the invention to further develop a fiber-optics plug connector system of the aforementioned kind such that different types and makes of single plug connectors can be combined to a multi-plug connector with the same connecting means in a simple way, wherein at the same time without further arrangements a sufficient play of the single plug connectors is ensured, as well as to provide a connecting clamp for such a system.

The object is solved by the entirety of the features of the claims 1 and 7. The core of the invention is that a connecting clamp is used for connecting and that the single plug connectors are combined with one another by the connecting clamp in the area of their anti-kink sleeves and are secured in parallel arrangement. Since the anti-kink sleeves conventionally are comprised of elastic material, an adaptation of connecting clamp and anti-kink sleeves can be achieved in a wide range and, at the same time, sufficient play for the two single plug connectors is provided.

A first preferred embodiment of the system according to the invention is characterized in that the receiving chambers of the clamp halves in their shape and dimension are embodied such that anti-kink sleeves with different outer diameters can be secured in them by clamping wherein for each anti-kink sleeve at least one receiving chamber with a polygonal, preferably trapezoidal, cross-section is provided and in that, in particular, in each of the clamp halves for each of the single plug connectors a receiving chamber is provided and that one of the two receiving chambers correlated with each single plug connector has a polygonal, preferably trapezoidal, cross-section and the other a round cross-section. By providing two receiving chambers with a polygonal and a round cross-section a relatively large tolerance range of anti-kink diameters can be clamped because they have sufficient space for an elastic deformation, in particular, on the polygonal side.

The manufacture and storage is further simplified when the two clamp halves according to a further preferred embodiment of the invention are identical and, by rotation about a rotational axis extending parallel to the insertion direction, can be transferred into one another.

In the case that the single plug connectors have levers arranged laterally on the housing for releasing the single plug connectors, as is disclosed in U.S. Pat. No. 5,675,682, it is advantageous that on the outer sides of the clamp halves slanted portions for receiving the levers are provided.

A preferred embodiment of the connecting clamp according to the invention is characterized in that the receiving chambers of the clamp halves in their shape and dimension are designed such that anti-kink sleeves with different outer dimensions can be secured in them by clamping, that for each anti-kink sleeve at least one receiving chamber with a polygonal, preferably trapezoidal, cross-section is provided, and that, in particular, in each of the clamp halves a receiving chamber is provided for each of the single plug connectors, respectively, and that one of the two receiving chambers correlated with each one of the single plug connectors has a polygonal, preferably trapezoidal, cross-section and the other has a round cross-section. The connection is improved here in that ribs extending transversely to the insertion direction are provided as an antislipping device in one or several receiving chambers.

Further embodiments result from the dependent claims.

### SHORT DESCRIPTION OF THE FIGURES

The invention will be explained in more detail in the following with the aid of embodiments in connection with the drawing. It is shown in:

FIG. 1 a perspective representation of a preferred embodiment of a connecting clamp according to the invention comprised of two identical clamp halves; and

FIG. 2, in a snapshot, the use of the connecting clamp according to FIG. 1 for connecting two single plug connectors with anti-kink sleeve in a snapshot.

### EMBODIMENTS FOR REALIZING THE INVENTION

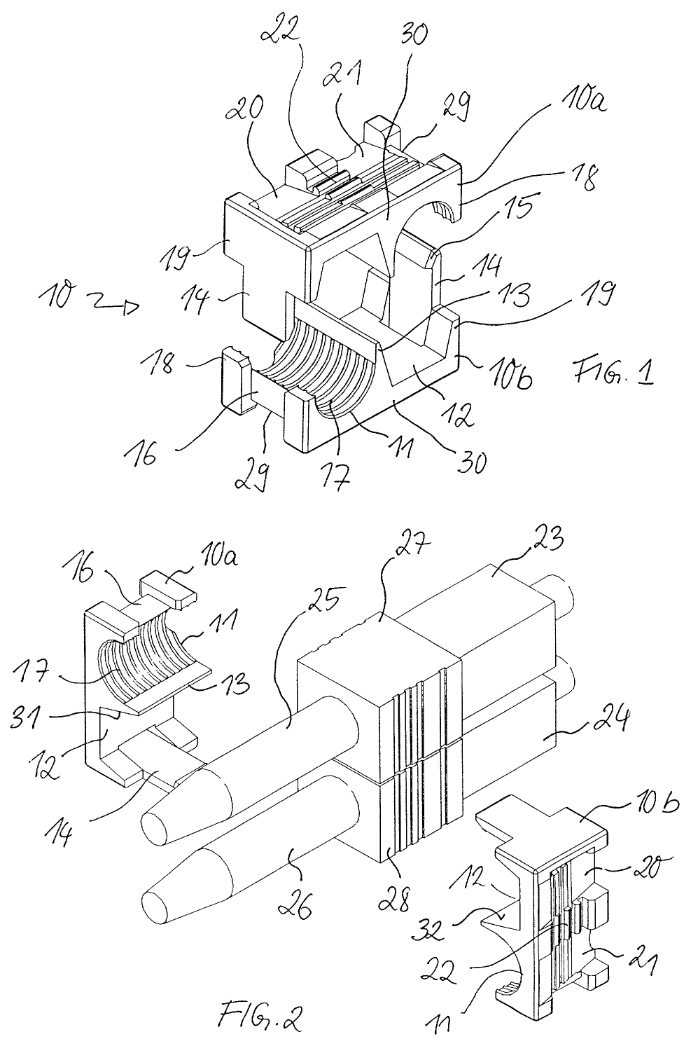

In FIG. 1 in a perspective illustration a preferred embodiment of a connecting clamp according to the invention is illustrated which is designed for connecting two single plug connectors, in particular, simplex plug connectors. The connecting clamp 10 comprises two identical clamp halves 10a and 10b which in the illustrated arrangement can be transferred into one another by a 180° rotation about a central axis parallel to the longitudinal axis of the plug connector. Each of the clamp halves 10a,b comprises a base plate 30 on which two sidewalls 18, 19 and a central wall 13, arranged between the sidewalls 18, 19, are formed to extend perpendicularly thereto. The first sidewall 18 and the central wall 13 form together a first receiving chamber 11 for an anti-kink sleeve of a first single plug connector. The first receiving chamber 11 has a round or semi-circular cross-section. At its inner side parallel ribs 17 are arranged, which when the single plug connectors (23, 24 in FIG. 2) are clamped, press into the relatively soft anti-kink sleeve (25, 26 in FIG. 2) and thus prevent slipping of the plug connector in the insertion direction. The second sidewall 19 and the central wall 13 form between them a second receiving chamber 12. The second receiving chamber 12 has a polygonal cross-section, in this embodiment a trapezoidal cross-section, with slanted sidewalls whose spacing from one another increases in the outward direction. When the second receiving chamber 12 receives the usually round anti-kink sleeve of an single plug connector, empty intermediate spaces result because of the mismatch between the round and the trapezoidal cross-section into which the elastically deformable anti-kink sleeve can spread for adaptation.

The two clamp halves 10a and 10b with the two different receiving chambers 11 and 12 are arranged according to FIGS. 1 and 2 opposite one another and are connected to one another by snapping into place such that for each of the single plug connectors 23, 24 to be connected a complete receiving chamber is available, respectively, with one half thereof being composed of a first and a second receiving chamber 11, 12, respectively. With reference to FIG. 2 this means that the upper anti-kink sleeve 25 is secured in a receiving chamber which is composed of a first (round) receiving chamber 11 of the left clamp half 10a and the second (trapezoidal) receiving chamber 12 of the right clamp half 10b. The conditions are exactly reverse for the lower anti-kink sleeve 26. The combination of a round with a trapezoidal receiving chamber provides a good and slip-safe clamping of each single plug connector 23, 24 for a relatively large tolerance range of anti-kink sleeve diameters. As a result of the round receiving side (receiving chamber 11) being provided with ribs 17, it is ensured that the connecting clamp 10 is secured fixedly on the anti-kink sleeve and can not be moved. With the slanted (trapezoidal) shape on the other receiving side it is made possible that all common plug connector types and makes can be clamped and thus can be duplexed.

For a snap connection of the two clamp halves 10a and 10b, a formed catch tongue 14 with a catch nose 15 (on one clamp have) and a catch tongue guide 16 with a catch edge 29 (at the other clamp half) are provided as catching and connecting means on the transverse sides. When the two clamp halves 10a,b in the arrangement according to FIG. 1 are moved toward one another, the catch tongues 14 engage the catch tongue guides 16 and glide therein until the (elastically bendable) catch tongues 14 with their catch noses 15 snap into place behind the catch edges 29. The pressing force required for a safe snap connection of the catch tongues 14 in the catch tongue guides 16 is generated in that the slanted inner walls 31, 32 of the trapezoidal receiving chambers 12, when closing the connecting clamp 10, glide along one another and effect a transverse movement of the clamp halves 10a,b relative to one another which assists in snapping into place.

At the outer sides of the base plate 30, transversely extending grip ribs 22 are formed in a central strip of the clamp halves 10a,b, respectively. These grip ribs 22 make possible a safe griping of the connecting clamp 10 during actuation of the completely mounted multiple connector. Accordingly, the single plug connectors 23, 24 of the duplex arrangement must not be gripped at their housings 27, 28, at least not during insertion, so that a non-uniform loading of the duplex arrangement during actuation is prevented. As can be seen in FIG. 2, the two clamp halves 10a,b of the connecting clamp 10 clamp the single plug connectors 23, 24 in the area of the anti-kink sleeves 25 and 26 directly behind the housings 27 and 28. Upon insertion of the multiple plug connector the insertion force can thus be introduced directly and uniformly from the connecting clamp into the two housings 27, 28.

The base plate 30 is provided with slanted portions 20, 21 on both sides of the central strip with the grip ribs 22. These slanted portions 20, 21 provide space for receiving possibly present release levers which may be provided on the single plug connectors. Even though such release levers are not provided in the exemplary single plug connectors 23, 24 of FIG. 2, they can be present in other plug connectors types in which the invention can be used with advantage (see, for example, EP-A1-0 823 649).

The clamping halves 10a,b are comprised, for example, of a suitable plastic material and are manufactured preferably as injection molded parts. Since the two clamp halves 10a,b are identical, the manufacture requires only one injection molding mold. At the same time, storage is simplified. Since an embodiment of the connecting clamp 10 can be used for plug connector types with different diameters of the anti-kink sleeve, a considerably simplified storage and manipulation in the field is possible.

The invention has been explained above in connection with two single plug connectors (in particular, simplex plug connectors) combined to a double plug connector (duplex plug connector). However, it is understood that in the context of the invention also more than two single plug connectors can be combined to a corresponding multi-plug connector.

### LIST OF REFERENCE NUMERALS

10 connecting clamp

10a,b clamp half

11 receiving chamber (round)

12 receiving chamber (trapezoidal)

13 central wall

14 catch tongue

15 catch nose

16 guide (catch tongue)

17 rib

18, 19 sidewall

20, 21 slanted portion

22 grip rib

23, 24 single plug connector

25, 26 anti-kink sleeve

27, 28 housing

29 catch edge

30 base plate

31, 32 slanted wall

1. A fiber-optics plug connector system in which several fiber-optics single plug connectors (23, 24) are to be connected in parallel arrangement by means of a connecting clamp (10) to a multi-plug connector, wherein the connecting clamp (10) is comprised of two clamp halves (10a, 10b) which can be connected by a snap connection with one another and have receiving chambers (11, 12) for receiving and securing the two single plug connectors (23, 24), and wherein each single plug connector (23, 24) has a housing (27, 28) and an anti-kink sleeve (25, 26) adjoining the housing (27, 28) to the rear, characterized in that the single plug connectors (23, 24) are connected by the connecting clamp (10) in the area of their anti-kink sleeves (25, 26) and are secured in parallel arrangement.

2. The plug connector system according to claim 1, characterized in that the receiving chambers (11, 12) of the clamp halves (10a, 10b) in their shape and dimension are formed such that anti-kink sleeves (25, 26) with different outer diameters can be secured therein by clamping.

3. The plug connector system according to claim 2, characterized in that for each anti-kink sleeve (25, 26) at least one receiving chamber (12) is provided with a polygonal, preferably trapezoidal, cross-section.

4. The plug connector system according to claim 3, characterized in that in each one of the clamp halves (10a, 10b) for each one of the single plug connectors (23, 24) a receiving chamber (11, 12) is provided, and that one of the two receiving chambers (11, 12) correlated with each one of the single plug connectors (23, 24) has a polygonal, preferably trapezoidal, cross-section and the other a round cross-section.

5. The plug connector system according to one of the claims 1 to 4, characterized in that the two clamping halves (10a, 10b) are identical and can be transferred into one another by rotation about a rotational axis parallel to the insertion direction.

6. The plug connector system according to one of the claims 1 to 5, characterized in that on the outer sides of the clamp halves (10a, 10b) slanted portions 20, 21) for receiving levers are formed which can be provided for releasing the single plug connectors (23, 24).

7. A connecting clamp (10) for a plug connector system according to one of the claims 1 to 6, comprised of two clamp halves (10a, 10b) which can be connected by a snap connection with one another and have receiving chambers (11, 12) for receiving and securing two single plug connectors (23, 24) provided with anti-kink sleeves (25, 26), characterized in that the receiving chambers (11, 12) of the clamping halves (10a, 10b) in their shape and dimension are formed such that, when the connecting clamp (10) is mounted, the anti-kink sleeves (25, 26) of the single plug connectors (23, 24) are secured therein by clamping.

8. The connecting clamp according to claim 7, characterized in that the receiving chambers (11, 12) of the clamp halves (10a, 10b) in their shape and dimension are formed such that anti-kink sleeves (25) with different outer diameters are secured in them by clamping.

9. The connecting clamp according to claim 8, characterized in that for each anti-kink sleeve (25, 26) at least one receiving chamber (12) with a polygonal, preferably trapezoidal, cross-section is provided.

10. The connecting clamp according to claim 9, characterized in that in each of the clamping halves (10a, 10b) a receiving chamber (11, 12) is provided for each of the single plug connectors (23, 24) and that one of the two receiving chambers (11, 12) correlated with each one of the single plug connectors (23, 24) has a polygonal, preferably trapezoidal, cross-section and the other a round cross-section.

11. The connecting clamp according to one of the claims 7 to 10, characterized in that the two clamping halves (10a, 10b) are identical and can be transferred into one another by rotation about a rotational axis extending parallel to the insertion direction.

12. The connecting clamp according to claim 10, characterized in that in at least one of the receiving chambers (10, 11) ribs (17) are arranged transversely to the insertion direction as an antislipping device.

13. The connecting clamp according to one of the claims 1 to 12, characterized in that on opposite sides of the clamping halves (10a, 10b) means (14, 15, 16) for snapping into place the clamping halves (10a, 10b) are provided, respectively.

14. The connecting clamp according to claim 13, characterized in that the catch means comprise a catch tongue (14) with a catch nose (15) on one clamp half and a guide (16) for the catch tongue (14) with a catch edge (29) on the other clamp half, respectively.

15. The connecting clamp according to claim 14, characterized in that the required pressing force of the catch tongues (14) for a safe snap connection is generated in the catch tongue guides (16) in that slanted walls (31, 32) on the clamp halves (10a,b) during closing of the connecting clamp (10) glide along one another and effect a transverse movement of the clamp halves (10a,b) relative to one another which assists in snapping into place.

16. The connecting clamp according to claim 14, characterized in that the clamping halves (10a, 10b) are produced as single-piece injection molded parts from a plastic material, respectively, and that the catch tongue (14) with the catch nose (15) is formed on the clamp half, respectively.
